(19) United States
(12) Patent Application Publication
(10) Pub. No.: US 2025/0194658 A1
(43) Pub. Date: Jun. 19, 2025

(54) CONTINUOUS POPCORN MACHINES HAVING ANGLED PADDLES AND/OR FLUID HEATED TROUGHS

(71) Applicant: C. Cretors & Company, Wood Dale, IL (US)

(72) Inventors: Charles D. Cretors, Lake Forest, IL (US); Kristen A. Brennan, Arlington Heights, IL (US); Nenad Vidojevic, Chesterton, IN (US); Patrick John Concannon, Wood Dale, IL (US); Athanasios Kremmydas, Mokena, IL (US)

(21) Appl. No.: 18/988,567

(22) Filed: Dec. 19, 2024

Related U.S. Application Data
(60) Provisional application No. 63/612,329, filed on Dec. 19, 2023.

(51) Int. Cl. A23L 7/183; A23P 30/38

(52) U.S. Cl. CPC A23P 30/38; A23L 7/183

(57) ABSTRACT

Popcorn machines having angled paddles and/or fluid heated troughs, and associated systems and methods of operation are disclosed herein. In some embodiments, a popcorn machine includes a trough, a shaft extending along the trough, and a paddle assembly coupled to the shaft. The paddle assembly includes both forward-facing paddles and backward-facing paddles that can continuously move ingredients back and forth in the trough without changing the rotation direction of the shaft. In some embodiments, a popcorn machine includes one or more heating units coupled to an external surface of a trough. Heat transfer fluid can be pumped through chambers defined by the heating units to provide heat to, without mixing with, ingredients in the trough. The temperature and the flow rate of the heat transfer fluid can be controlled to provide various heating profiles along a length of the trough.

### CROSS-REFERENCE TO RELATED APPLICATION(S)

The present application claims the benefit of U.S. Provisional Patent Application No. 63/612,329, filed Dec. 19, 2023, the disclosure of which is incorporated herein by reference in its entirety.

### TECHNICAL FIELD

The following disclosure relates generally to popcorn machines and, more particularly, to popcorn machines having angled paddles and/or fluid heated troughs, and associated systems and methods.

### BACKGROUND

In typical popcorn machines designed for commercial popcorn production, thermostats are used to control the popping cycles of high output kettles. More particularly, feedback from the thermocouples is used to control heating elements that heat the kettles and corn kernels therein at rates that prevent burning and yet ensure that the corn kernels pop. The controlled cooking cycle in these high output kettles can produce consistent and high-quality popcorn. In previous designs of continuous popcorn machines, attempts to produce popcorn of similar quality have been unsuccessful.

In kettle-based popcorn machines, various flavorings and coatings can be added to the kettle to produce flavored or coated popcorn (e.g., kettle corn). However, in popcorn machines employing rotating mesh drums or other flowthrough or continuous popping systems (e.g., auger driven popcorn machines), flavorings or coatings are typically added after the popping process is completed and the popcorn has been removed from the popping container. The reason for this is that adding flavorings or sugar coatings during the popping process can result in accumulation of these ingredients within the drum, auger, or associated components and/or the flavorings or sugar coatings falling through the rotating mesh drums. For example, sticky flavorings can accumulate in components of the machine and, absent time-consuming and costly cleaning, prevent rotation of the components or significantly reduce heat transfer between heating elements of the machine and the ingredients.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present technology.

FIG. 1 is a partially schematic, left isometric view of a popcorn machine system configured in accordance with embodiments of the present technology.

FIG. 2 is an enlarged right isometric view of a portion of the popcorn machine system of FIG. 1.

FIGS. 3A, 3B, and 3C are top left isometric, bottom left isometric, and cross-sectional views, respectively, of portions of a popcorn machine of the popcorn machine system of FIGS. 1 and 2, configured in accordance with embodiments of the present technology.

FIGS. 4A-4C are schematic diagrams of a trough heating system of the popcorn machine system of FIGS. 1 and 2, configured in accordance with embodiments of the present technology.

FIG. 4D is a graph illustrating example changes in temperature of a heat transfer fluid and ingredients along a length of a trough, in accordance with embodiments of the present technology.

FIG. 5 is an isometric view of an ingredient moving paddle of the popcorn machine of FIGS. 3A-3C, configured in accordance with embodiments of the present technology.

FIG. 6A is a top right isometric view of a portion of the popcorn machine of FIGS. 3A-3C.

FIG. 6B is a top view of a portion of the popcorn machine of FIGS. 3A-3C illustrating operation of a paddle assembly configured in accordance with embodiments of the present technology.

### DETAILED DESCRIPTION

Embodiments of the present technology are generally directed to devices and methods for heating and cooking a food product, such as corn kernels to make popcorn. In some embodiments, for example, a popcorn machine includes a trough and a cover extending along a longitudinal axis. The trough and the cover form a circumferential boundary of a cylindrical process chamber through which ingredients can be moved to produce, for example, popcorn. The popcorn machine can include an ingredient moving assembly that moves the ingredients through the process chamber in a desired manner. The popcorn machine can also include a trough heating system that heats the trough and thereby heats the ingredients moving across the trough for proper cooking (e.g., popping of corn kernels).

In some embodiments, the ingredient moving assembly comprises a plurality of paddles mounted on a central, rotating shaft extending along the longitudinal axis. The paddles can include spring-loaded blades that maintain contact with the inner surface of the trough as the shaft rotates. As described in greater detail below, the paddles can be positioned at various angles to move ingredients (e.g., popcorn kernels, oil, etc.) back and forth inside the process chamber as the ingredients move down the length of the trough. The embodiments of ingredient moving assemblies described herein can be used in popcorn machines with various types of trough heating systems, and are not limited to use with the trough heating systems described herein.

In some embodiments, the trough heating system comprises one or more heating units positioned on the outer surface of the trough. Heated fluid can be pumped or otherwise circulated through the heating units to heat corresponding zones of the trough. The one or more heating units can define one or more zones on the trough to provide one or more corresponding heating profiles that may differ from one another. The temperature and flow rate of the heated fluid can be controlled to achieve a desired heating profile (e.g., to emulate the heating cycle provided by a conventional batch kettle for producing popcorn).

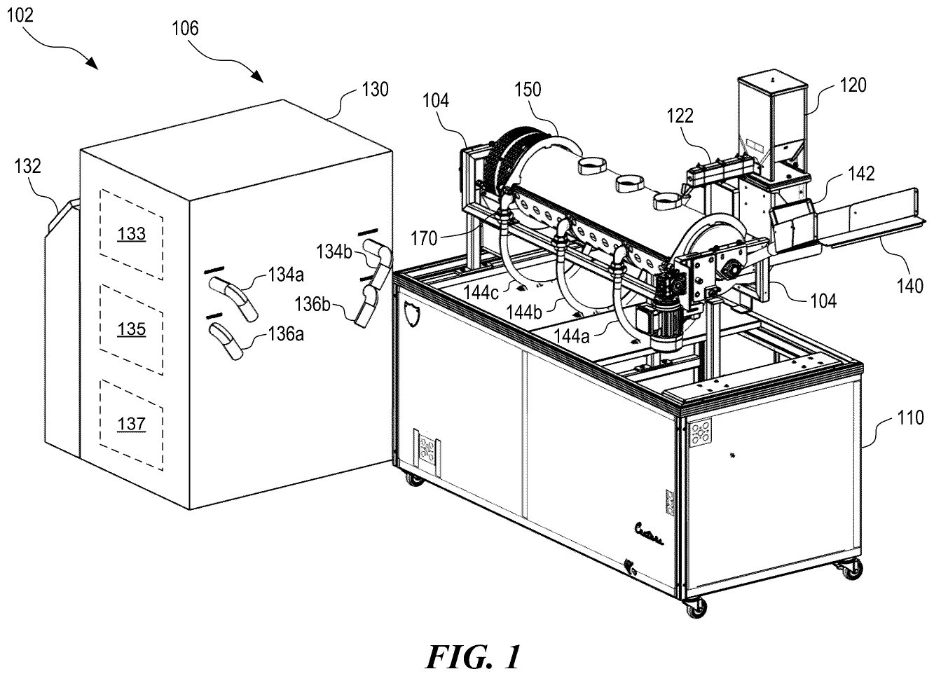

As discussed above, existing continuous or flow-through popcorn machines may not produce consistent, high-quality popcorn. The present technology includes several embodiments of popcorn machines having process chambers with angled paddles and multi-zone heating that can consistently produce high-quality popcorn and coated popcorn. Certain details are set forth in the following description and FIGS. 1-6B to provide a thorough understanding of various embodiments of the disclosure. Other details describing well-known structures and systems often associated with popcorn machines, popping chambers, etc., and/or the components or devices often associated with the manufacture of popcorn machines, are not set forth below to avoid unnecessarily obscuring the description of the various embodiments of the disclosure.

In the Figures, identical reference numbers identify identical, or at least generally similar, elements. Many of the details, dimensions, and other features shown in the Figures are merely illustrative of particular embodiments of the disclosed technology and may not be drawn to scale. Accordingly, other embodiments can have other details, dimensions, and features without departing from the spirit or scope of the disclosure. In addition, those of ordinary skill in the art will appreciate that further embodiments of the disclosed technologies can be practiced without several of the details described below.

FIG. 1 is a partially schematic, left isometric view of a popcorn machine system 102 (“system 102”) configured in accordance with embodiments of the present technology. In the illustrated embodiment, the system 102 includes a base 110, a sugar melting assembly 120, a trough heating system 106, and a popcorn machine 150. The system 102 also includes a corn kernel ramp 140 and a corn kernel intake 142 coupled to the popcorn machine 150.

The base 110 can provide support for the sugar melting assembly 120 and the popcorn machine 150. For example, the sugar melting assembly 120 and the popcorn machine 150 can be mounted on one or more frames 104 supported by the base 110. The base 110 can also house various components of the system 102, such as pipes, motors, electrical components, etc. The sugar melting assembly 120 can be positioned adjacent the popcorn machine 150 and include a sugar outlet chute 122 that extends toward the popcorn machine 150.

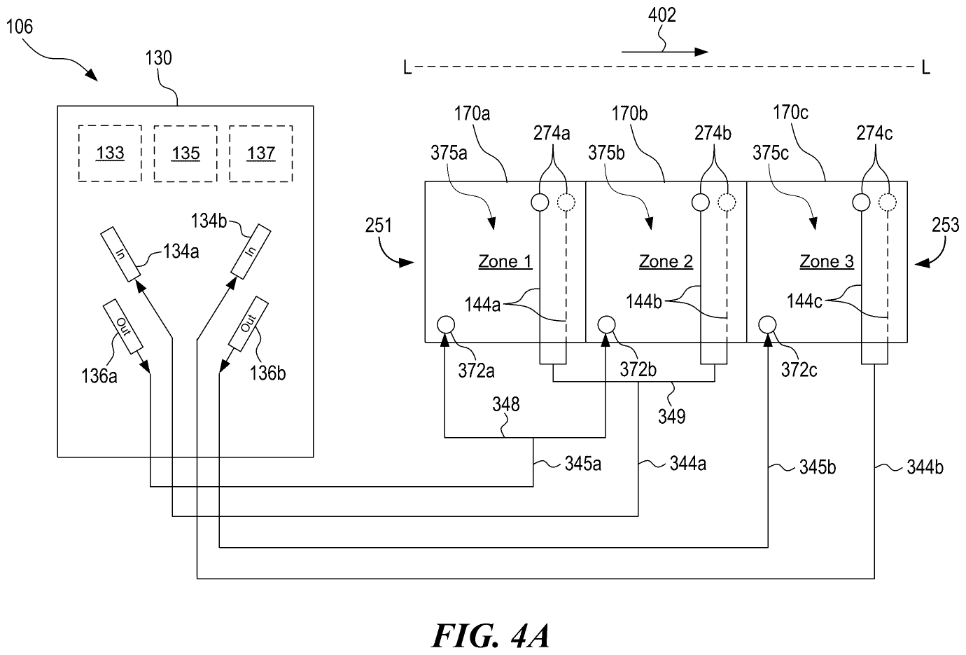

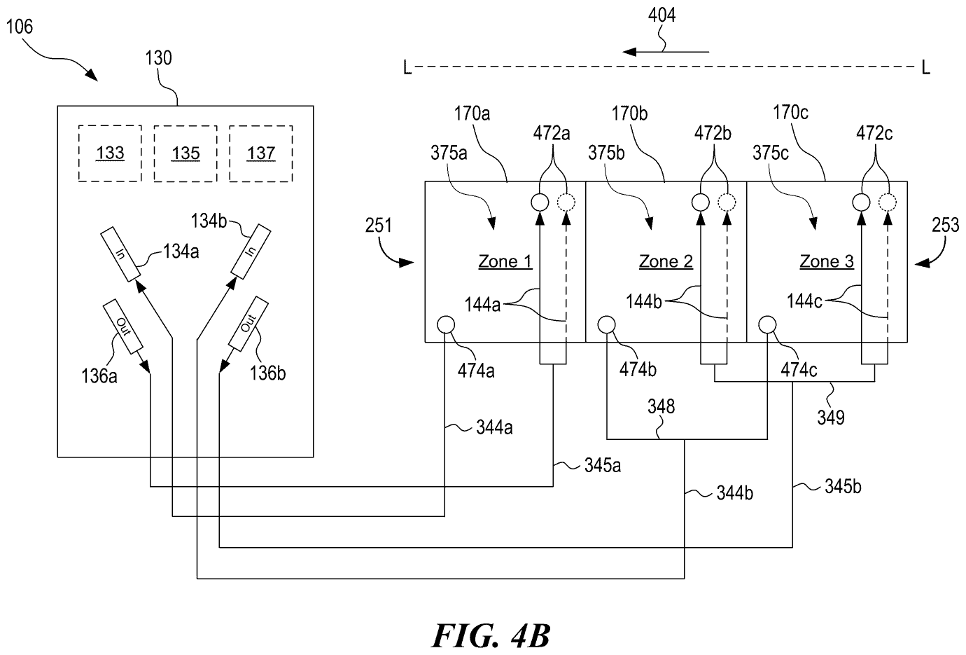

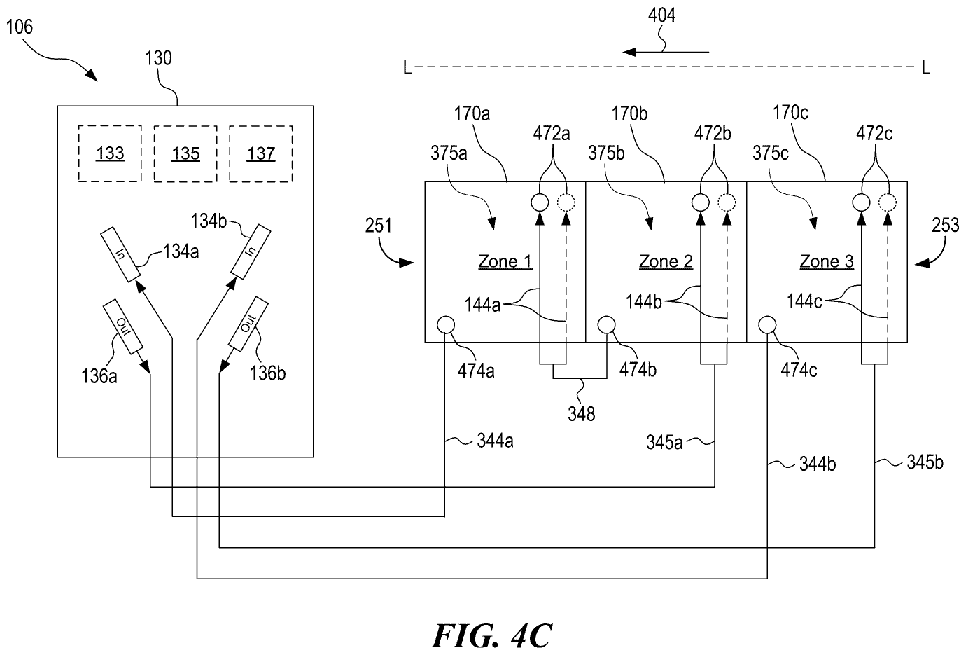

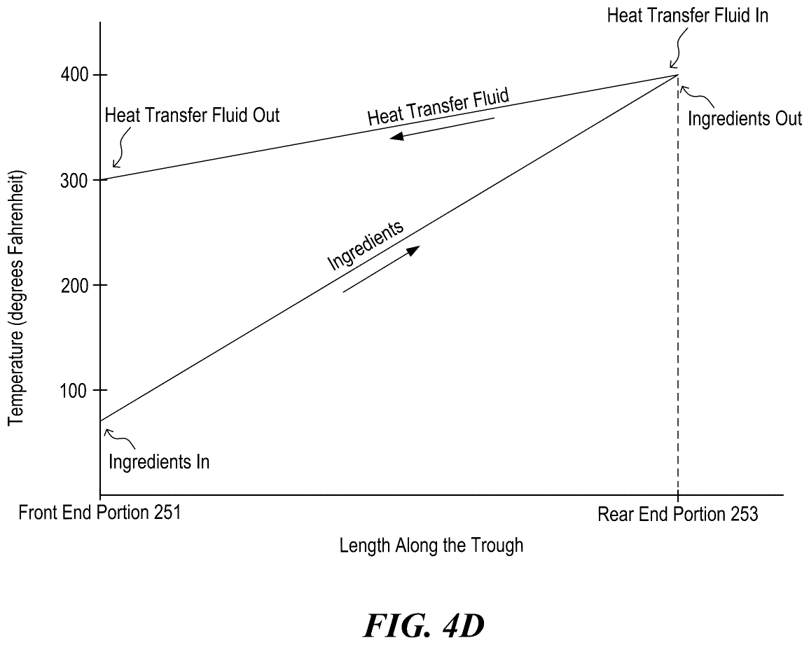

The trough heating system 106 can include a fluid heating and pump assembly 130 (“the heating and pump assembly 130”) and one or more trough heating units 170 that are coupled to and form part of the popcorn machine 150. The heating and pump assembly 130 can include a control panel 132 having a user interface, a control system 135 (shown schematically), one or more fluid pumps 133 (shown schematically), one or more fluid heating elements 137 (e.g., a resistive heater, an atmospheric or gas-burning heater, an inductive heater) (also shown schematically), one or more fluid inlets 134a-b, and one or more fluid outlets 136a-b. The heating and pump assembly 130 can be operably coupled in fluid communication with the heating units 170, as described in greater detail below with reference to FIGS. 4A-4C. For example, in some embodiments the fluid outlets 136a-b can be configured to provide heat transfer fluid to the heating units 170, and the fluid inlets 134a-b can be configured to receive the heat transfer fluid from the heating units 170 (via, e.g., conduits 144a-c). The control system 135 can be operatively coupled to the one or more pumps 133 and to the one or more heating elements 137 and operated via the control panel 132. In some embodiments, the control system 135 can include at least one processor (e.g., a CPU(s), GPU(s), PLC(s), etc.), at least one non-transitory computer readable medium, e.g., memory, that stores computer-executable instructions for execution by the processor, and at least one communication device.

The processor can be a single processing unit or multiple processing units in a device or distributed across multiple devices. The processor can be coupled to other hardware devices, for example, with the use of a bus, such as a PCI bus or SCSI bus. The processor can communicate with a hardware controller for devices, such as for the user interface of the control panel 132. The user interface of the control panel 132 can be used to display text and graphics via a display and/or receive control inputs via an input device. Examples of display devices are: an LCD display screen, an LED display screen, a projected, holographic, or augmented reality display (such as a heads-up display device or a head-mounted device), and so on. The communication device can be capable of communicating wirelessly or wire-based with a network node. The communication device can communicate with another device or a server through a network using, for example, TCP/IP protocols. The control system 135 can utilize the communication device to distribute operations across multiple network devices.

The memory can include one or more hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. The memory is not a propagating signal divorced from underlying hardware; the memory is thus non-transitory. The memory can include program memory that stores programs and software. The memory can also include data memory, e.g., table data, column data, value filter data, user interface data, database element data, selection data, root table data, code snippet data, join query data, query template data, connection data, configuration data, settings, user options or preferences, etc., which can be provided to the program memory or any element of the control system 135. Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, distributed computing environments that include any of the above systems or devices, or the like.

Components of the control system 135 (e.g., the memory) can store instructions that, when executed by the processor, cause the control system 135 to operate the one or more pumps 133 and the one or more heating elements 137 to control flow and temperatures, respectively, of the heat transfer fluid pumped into and out of the heating units 170.

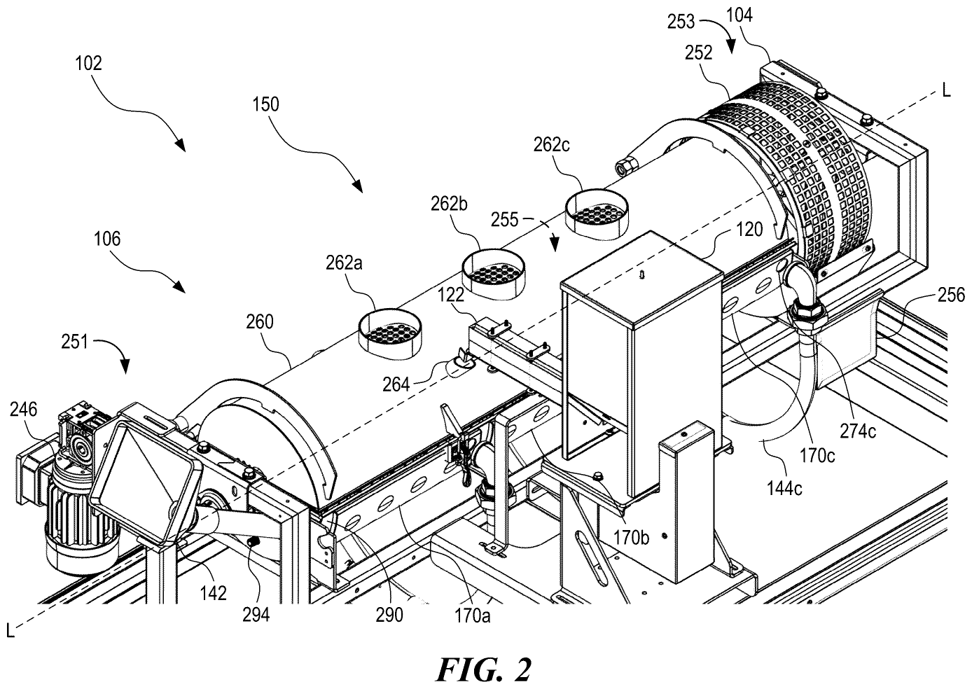

FIG. 2 is an enlarged right isometric view of a portion of the popcorn machine system 102 including the popcorn machine 150. The popcorn machine 150 can include a trough 290 and a cover 260 that extend longitudinally from a front end portion 251 of the popcorn machine 150 toward a rear end portion 253 of the popcorn machine 150 along a longitudinal axis L-L. The trough 290 and the cover 260 can each have half-cylinder shapes with semi-circular cross-sections that together form a cylindrical or tubular process chamber 255 having a circular, or at least approximately circular, cross-section. The trough 290 and the cover 260 can be made from suitable metal or metal alloys (e.g., stainless steel) via a variety of fabrication methods known in the art, including casting, cutting, rolling, bending, welding, etc. The cover 260 can be removably disposed over the trough 290 via, e.g., one or more hinges coupling a side edge portion of the cover 260 to a corresponding side edge portion of the trough 290. The trough 290, which can have a half-cylindrical shape, can have an inner diameter between 5−20 inches, such as about 10 inches. The trough 290 can have a length between 20−100 inches, such as about 45 inches. The front end portion 251 of the popcorn machine 150 can be operably coupled to the corn kernel intake 142 and can include a cooking oil inlet 294. Prior to or during operation of the popcorn machine 150, corn kernels and cooking oil (e.g., sunflower oil) can be introduced into the front end portion of the process chamber 255 via the corn kernel intake 142 and the cooking oil inlet 294, respectively.

The cover 260 can include one or more exhaust outlets 262a-c and a sugar inlet 264. The exhaust outlets 262a-c can be positioned in a row parallel to the longitudinal axis L-L to provide an exhaust path for steam, gases, particulates, and/or other by-products (i.e., process emissions) produced within the process chamber 255 during popping and/or coating operations. The sugar inlet 264 can be fluidly coupled to the chute 122 or be positioned underneath the chute 122 (as shown) such that the melted sugar (and/or other additives) flows into the process chamber 255 and mixes with the corn kernels and cooking oil (and/or other ingredients) therein.

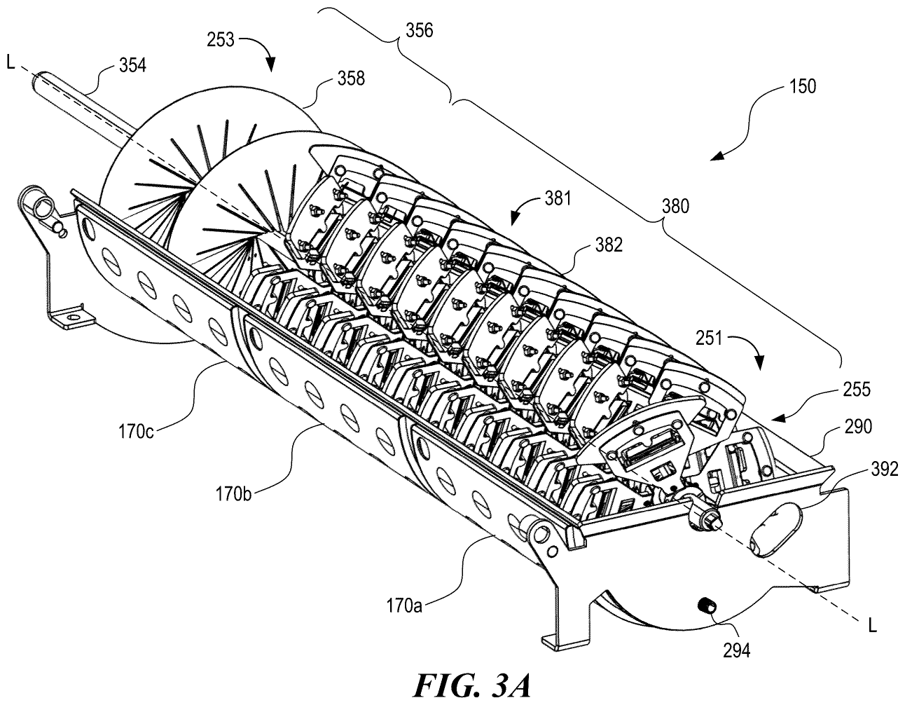

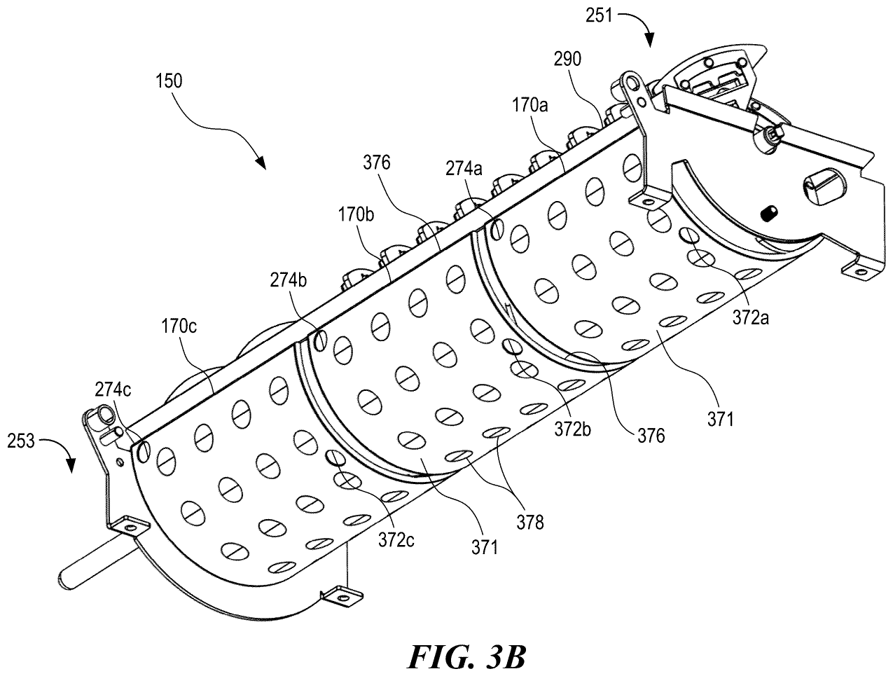

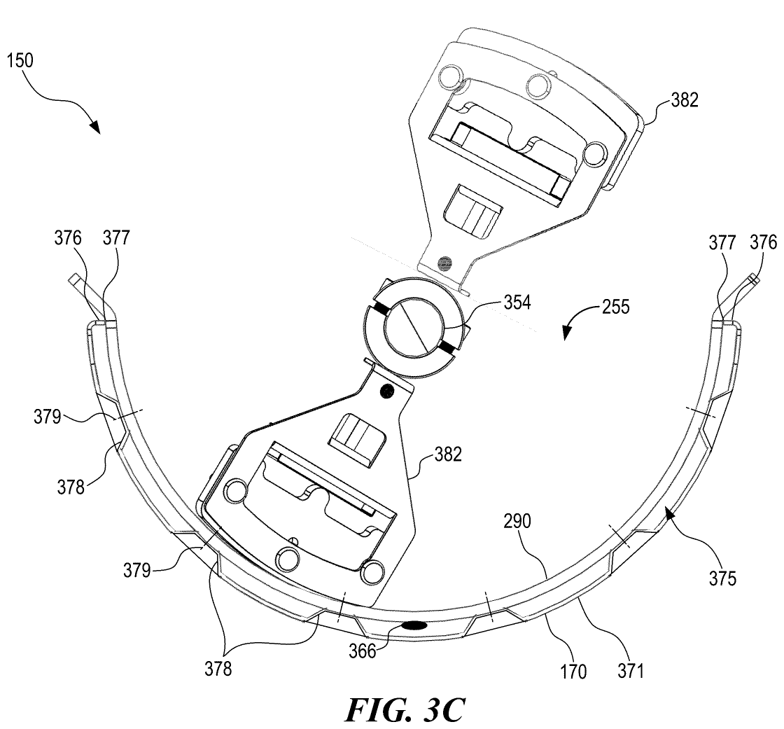

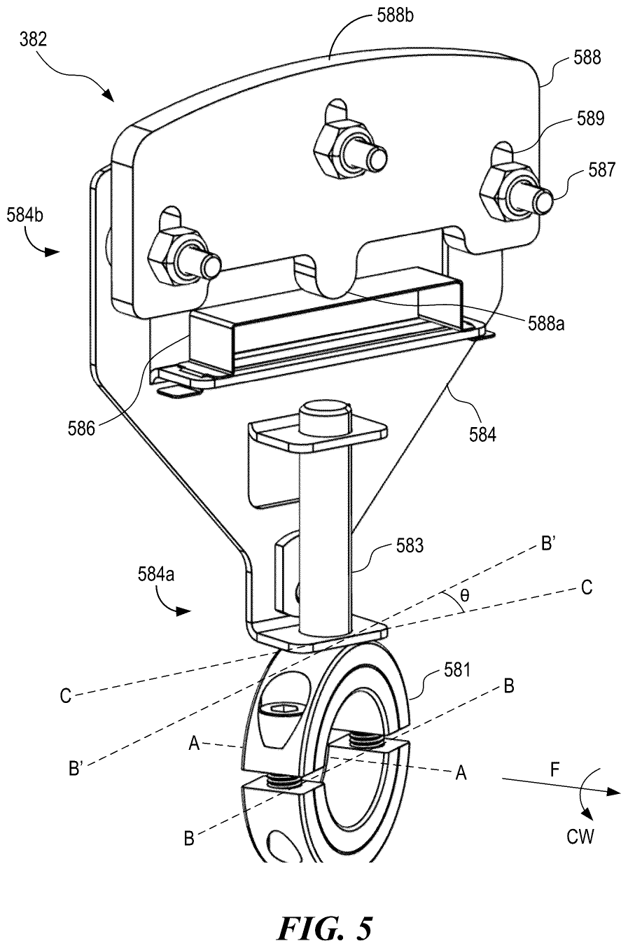

The popcorn machine 150 can also include a central shaft (shown in FIG. 3A) rotatably disposed within the process chamber 255 and extending along the longitudinal axis L-L, a sifting and cooling assembly 252 coupled to rotate with the shaft at the rear end portion 253 of the popcorn machine 150, a motor 246 operatively coupled to rotate the shaft, and the one or more heating units 170 (identified individually at heating units 170a-c) coupled to an external surface of the trough 290 parallel to the longitudinal axis L-L. As described in further detail below with reference to FIG. 3B, each of the heating units 170a-c includes an internal chamber having at least one fluid inlet (not shown in FIG. 2) and at least one fluid outlet 274 (e.g., outlet 274c is illustrated for heating unit 170c). The fluid conduits 144a-c can be fluidly coupled to the corresponding outlets 274a-c (the fluid conduit 144c is shown disconnected from the outlet 274c in FIG. 2 for purposes of illustration). As described in further detail below with reference to FIGS. 4B and 4C, in some embodiments fluid can be pumped into the outlets 274a-c via the fluid conduits 144a-c, respectively, in which case the outlets 274a-c serve as fluid inlets instead of fluid outlets. The motor 246 can be directly coupled to the shaft or indirectly coupled to the shaft, via, e.g., gears, chains, and/or other suitable drive mechanisms, etc. As described in further detail below with reference to FIG. 5, rotation of the shaft causes the ingredients (e.g., corn kernels, cooking oil, additives, etc.) to mix and move from the front end portion of the trough 290 to the rear end portion of the trough 290.

Once the food products, such as popcorn and/or other processed ingredients, reach the rear end of the trough 290, the sifting and cooling assembly 252, which rotates with the shaft, can sift out unpopped corn kernels and excess cooking coil and/or additives. In some embodiments, the unpopped corn kernels and excess cooking coil and/or additives are dropped into a receiving chute or receptacle 256 positioned beneath the sifting and cooling assembly 252. A chute or hopper (not shown) can be positioned adjacent the receptacle 256 to receive product (e.g., popcorn, caramel corn, etc.) from the sifting and cooling assembly 252. The popcorn machine 150 can be used to make food products with or without additives.

FIGS. 3A, 3B, and 3C are top isometric, bottom isometric, and cross-sectional views, respectively, of the popcorn machine 150 with the cover 260 (FIG. 2) removed to better illustrate certain aspects of the present technology. Referring first to FIG. 3A, in the illustrated embodiment, the popcorn machine 150 includes a paddle zone 380 extending from the front end portion 251 along the longitudinal axis L-L, and an auger zone 356 extending from the paddle zone 380 to the rear end portion 253 along the longitudinal axis L-L. The paddle zone 380 can include a paddle assembly 381 comprising a plurality of paddles 382 operably coupled to the central shaft 354, and the auger zone 356 can include an auger 358 (e.g., a helical auger) coupled to the shaft 354. In various embodiments, the paddle assembly 381 can include 5, 10, 20, 30, 40, 50, 60, 70, 80, 90, or 100 of the paddles 382, any number therebetween, or fewer or more paddles. In some embodiments, the shaft 354 can be a metal member, such as a seamless stainless-steel rod or pipe that is formed via a continuous mandrel mill rolling processes, or a welded stainless steel pipe formed via an electric weld pipe mill. The auger 358 can be made from metal or metal alloys (e.g., stainless steel) via a variety of fabrication methods known in the art, including casting, cutting, rolling, bending, welding, etc. As shown, the auger 358 can be positioned closer to the rear end portion 253 of the popcorn machine 150 than the paddle assembly 381. Details of the components of the paddles 382 are described in further detail below with respect to FIG. 5.

In several embodiments, the popcorn machine 150 can include one or more components, devices, and/or features that are at least generally similar in structure and/or function to those described in U.S. Pat. No. 9,144,247, filed Apr. 20, 2012, and titled POPCORN POPPING MACHINES AND OTHER MACHINES HAVING FLOW THROUGH DECKS FOR POPPING POPCORN AND PRODUCING OTHER TYPES OF EXPANDED FOOD, and/or in U.S. Pat. No. 10,631,562, filed Nov. 22, 2017, and titled CONTINUOUS POPCORN MACHINES HAVING VARIABLE HEATING PROFILES AND ASSOCIATED SYSTEMS AND METHODS, both of which are incorporated herein by reference in their entirety.

Referring next to FIG. 3B, in the illustrated embodiment, the heating units 170a-c are mounted or otherwise coupled to the external surface of the trough 290 for efficient heat transfer therebetween. The trough 290 can comprise a half-cylinder shell with a semicircular cross-sectional shape, and each of the heating units 170a-c can comprise a jacket having an outer wall 371 in the form of a half-cylinder shell and a peripheral rim, flange, or edge portion 376 (hereinafter “the peripheral edge portion 376”) extending around the perimeter of the outer wall 371. In some embodiments, the length of each of the heating units 170a-c is between 5−30 inches, such as about 13 inches. In some embodiments, adjacent ones of the heating units 170a-c are spaced apart by a gap between 0.1−5 inches, such as about 1 inch.

Each of the heating units 170a-c includes one or more fluid inlets configured to receive heated fluid from the heating and pump assembly 130 (FIG. 1), and one or more fluid outlets configured to expel or return the heated fluid from the heating units 170a-c to the heating and pump assembly 130. For example, in the illustrated embodiment, each of the heating units 170a-c includes a single fluid inlet 372 (identified individually as fluid inlets 372a-c) and two fluid outlets 274 (identified individually as fluid outlets 274a-c). Although FIG. 3B shows only one fluid outlet 274 for each heating unit 170a-c positioned near an upper edge portion thereof, in the illustrated embodiment each of the heating units 170a-c can further include a second fluid outlet 274 near an opposite upper edge portion thereof, as shown schematically in FIGS. 4A-4C. The heated fluid can be any fluid suitable for efficient heat transfer such as oil, Duratherm FG, or other types of fluids, such as steam, other liquids, etc.

Referring next to FIGS. 3B and 3C together, in some embodiments, the outer wall 371 of each of the heating units 170a-c includes a plurality of recesses or dimples 378 formed therein and having, e.g., frustoconical shapes. In the illustrated embodiment, the outer wall 371 is attached to the trough 290 by spotwelds 379 (FIG. 3C) positioned at the bottom of each dimple 378. In other embodiments, the dimples 378 can be coupled to the trough 290 via sealed fasteners, adhesives, or other coupling mechanisms. In the illustrated embodiment, the dimples 378 are formed in a grid-like pattern in the outer wall 371 of each heating unit 170a-c. For example, the dimples 378 can be arranged in rows and columns and can be separated from adjacent dimples by 1 inch, 1.5 inch, 2 inches, or other distances.

In addition to the spotwelds 379, in the illustrated embodiment, the entire peripheral edge portion 376 of each outer wall 371 can be scalably attached to the trough 290 by means of a continuous seam weld 377 (FIG. 3C) to form a sealed interior chamber 375 extending between the inner surface of outer wall 371 of the heating unit 170 and the outer surface of the trough 290 in which to contain the heat transfer fluid. This configuration puts the heated fluid in direct contact with the exterior surface of the trough 290 to facilitate efficient heat transfer from the heated fluid to the trough 290, but isolates the heated fluid from the process chamber 255 to prevent the fluid from mixing with cooking oil or other ingredients. In some embodiments, each of the heating units 170a-c includes multiple inlets 372 and/or outlets 274. For example, each of the heating units 170a-c of the illustrated embodiment includes two outlets 274a-c, one on the upper left side (as shown in FIG. 3B) and another on the upper right side (as shown in FIG. 2). The outer wall 371 of the heating units 170a-c can be made from suitable metal or metal alloys (e.g., stainless steel) via a variety of fabrication methods known in the art, including press-forming, casting, cutting, rolling, bending, welding, etc. In some embodiments, the gap between each outer wall 371 and the outer surface of the trough 290 (e.g., the depth of the interior chamber 375 in the radial direction) is no more than 3 inches, 1 inch, or 0.5 inch, such as about 0.256 inch.

The dimples 378 can also obstruct the flow of the heat transfer fluid within the interior chamber 375 such that the heat transfer fluid must flow around the dimples 378, which can be advantageous to create more distributed fluid flow through the interior chamber 375, and thus better distributed heat transfer to the ingredients in the tubular process chamber 255. In some embodiments, the distance between adjacent dimples 378 is between 1−5 inches, such as 3 inches.

Referring to FIGS. 1-3C together, during operation of the popcorn machine 150, corn kernels and cooking oil are introduced into the process chamber 255 via corn kernel opening 392 (which can receive the corn from the corn kernel intake 142) and the cooking oil inlet 294, respectively. The motor 246 can be operated to rotate the shaft 354 in a desired direction (e.g., clockwise), to thereby rotate the paddle assembly 381, the auger 358, and the sifting and cooling assembly 252 about the longitudinal axis L-L. The rate of rotation of the shaft 354 can be about 2 revolutions per minute (rpm), 4 rpm, 6 rpm, 8 rpm, 10 rpm, 12 rpm, 14 rpm, 16 rpm, 18 rpm, 20 rpm, any rpm therebetween, or a lower or higher rpm. As the paddles 382 rotate they mix and move the ingredients toward the auger 358. By the time the ingredients reach the auger 358, most or at least some of the ingredients are fully processed (e.g., corn kernels have popped to become popcorn). The auger 358 can then move the processed food products toward the sifting and cooling assembly 252 (FIG. 2).

In some embodiments, the popcorn machine 150 includes one or more temperature sensors 366 (FIG. 3C), e.g., thermocouples, positioned along the length of the trough 290, on the cover 260 (FIG. 2), and/or within the tubular process chamber 255 to monitor and/or facilitate control of the temperature therein.

In some embodiments, the heating units 170a-c can comprise hollow, enclosed structures that define interior chambers (e.g., the interior chamber 375) independently of the trough 290. A primary advantage of this configuration is that such heating units do not rely on welds, which can often be the weak points in structures, to contain the pressure of the heat transfer fluid flowing therethrough.

FIGS. 4A-4C are schematic diagrams illustrating operation of the trough heating system 106 in accordance with embodiments of the present technology. Specifically, FIG. 4A illustrates the heat transfer fluid flowing generally in a first direction 402 relative to the longitudinal axis L-L, and FIGS. 4B and 4C illustrate the heat transfer fluid b flowing generally in a second direction 404 relative to the longitudinal axis L-L opposite the first direction 402.

Referring first to FIG. 4A, the fluid outlets 136a-b of the fluid heating and pump assembly 130 are coupled in fluid communication to the fluid inlets 372a-c of the heating units 170a-c via conduits 345a-b, and the fluid outlets 274a-c of the heating units 170a-c are coupled in fluid communication to the fluid inlets 134a-b of the fluid heating and pump assembly 130 via conduits 344a-b. In operation, the heat transfer fluid is heated via the heating elements 137 and circulated (via the pump 133) from the pump assembly 130 to the heating units 170a-c via the fluid outlets 136a-b, the conduits 345a-b, and the fluid inlets 372a-c. The heated fluid flowing through the interior chambers 375a-c of the heating units 170a-c transfers heat to the ingredients in the process chamber 255 through direct contact of the heated fluid with the exterior surface of the trough 290. The heated fluid then flows out of the heating units 170a-c through the outlets 274a-c and back to the heating and pump assembly 130 through the conduits 344a-b and the inlets 134a-b to be reheated for recirculation through the heating units 170a-c.

As discussed above with reference to FIG. 1, the control system 135 can be operatively coupled to the one or more pumps 133 and the one or more heating elements 137 to control flow rates and temperatures, respectively, of the heat transfer fluid flowing into and out of the heating units 170a-c. Because the heating units 170a-c are arranged along the longitudinal axis L-L and the interior chambers 375a-c are separate from one another, each heating unit can define a zone (e.g., Zone 1, Zone 2, and Zone 3) that can be independently heated to, e.g., different temperatures by providing heat transfer fluid of different temperature profiles to the different heating units 170a-c. In some embodiments, however, two or more of the heating units 170a-c can be fluidly coupled such that two or more zones provide the same heating profile.

For example, in FIG. 4A, the inlets 372a and 372b are connected to each other in fluid communication via a conduit 348 and the outlets 274a and 274b are connected to each other in fluid communication via a conduit 349, while the inlet 372c and the outlets 274c are not fluidly coupled to any other inlets or outlets, respectively. Thus, the inlets 372a and 372b are coupled to share and receive a first stream of the heat transfer fluid, and the inlet 372c is coupled to receive a second stream of the heat transfer fluid different from the first stream. As a result, in the illustrated embodiment Zone 1 and Zone 2 are configured to provide the same (or at least approximately the same) heating profile, but at different positions along the length of the trough 290 (not shown in FIGS. 4A-4C), and Zone 3 can provide a different (e.g., lower, higher) heating profile. Because the heat transfer fluid is pumped into the fluid inlets 372a-c of each of the heating units 170a-c and flows out of the corresponding outlets 274a-c, the heat transfer fluid generally flows in the first direction 402 relative to the longitudinal axis L-L, which is the same general direction that the ingredients move in the trough 290 (not shown in FIGS. 4A-4C).

Referring next to FIG. 4B, in the illustrated embodiment the first fluid outlet 136a of the fluid heating and pump assembly 130 is coupled in fluid communication to fluid inlets 472a of the first heating unit 170a via the conduit 345a, and the first fluid inlet 134a of the fluid heating and pump assembly 130 is coupled in fluid communication to a fluid outlet 474a of the first heating unit 170a via the conduit 344a. It will be recognized that the fluid inlets 472a are the same orifices that were used for the fluid outlets 274a described above with reference to the embodiment of FIG. 4A; and that the fluid outlet 474a is the same orifice that was used for the fluid inlet 372a of the embodiment of FIG. 4A. The second fluid outlet 136b of the fluid heating and pump assembly 130 is coupled in fluid communication to fluid inlets 472b-c of the second and third heating units 170b-c, respectively, via the conduits 345b and 349. Fluid outlets 474b-c of the second and third heating units 170b-c, respectively, are coupled in fluid communication to the second fluid inlet 134b of the fluid heating and pump assembly 130 via the conduits 348 and 344b. It will be recognized that the fluid inlets 472b-c are the same orifices that were used for the fluid outlets 274b-c, respectively, described above with reference to the embodiment of FIG. 4A; and that the fluid outlets 474b-c are the same orifices that were used for the fluid inlets 372b-c, respectively, in the embodiment of FIG. 4A. Thus, the fluid inlets 472b and 472c are coupled to share and receive a first stream of the heat transfer fluid, and the inlet 472a is coupled to receive a second stream of the heat transfer fluid different from the first stream. In the illustrated embodiment, Zone 2 and Zone 3 can be configured to provide the same (or at least approximately the same) trough heating profile, but at different positions along the length of the trough 290, and Zone 1 can provide a different (e.g., lower, higher, etc.) heating profile. Moreover, because the heat transfer fluid flows from the fluid inlets 472a-c to the corresponding outlets 474a-c of each of the heating units 170a-c, the heat transfer fluid generally flows in the second direction 404 relative to the longitudinal axis L-L, which is generally opposite the direction that the ingredients move in the trough 290.

Referring next to FIG. 4C, in this embodiment the first fluid outlet 136a of the fluid heating and pump assembly 130 is coupled in fluid communication to the fluid inlets 472b of the second heating unit 170b via the conduit 345a. The fluid outlet 474b of the second heating unit 170b is connected in fluid communication to the fluid inlets 472a of the first heating unit 170a via the conduit 348. The fluid outlet 474a of the first heating unit 170a is coupled in fluid communication to the first fluid inlet 134a of the fluid heating and pump assembly 130 via the conduit 344a. The second fluid outlet 136b of the fluid heating and pump assembly 130 is coupled in fluid communication to the fluid inlets 472c of the third heating unit 170c via the conduit 345b. The fluid outlet 474c of the third heating unit 170c is coupled in fluid communication to the second fluid inlet 134b of the fluid heating and pump assembly 130 via the conduit 344b. Thus, the fluid inlets 472b are coupled to receive a first stream of the heat transfer fluid, the fluid inlets 472a are coupled to receive the same first stream of the heat transfer fluid (e.g., from the outlet 474b), and the fluid inlets 472c are coupled to receive a second stream of the heat transfer fluid different from the first stream. As a result of the foregoing configuration, in the illustrated embodiment each of the Zones 1, 2, and 3 can be configured to provide a different heating profile. For example, because the heat transfer fluid dissipates some of its heat before flowing out of Zone 2 and into Zone 1, Zone 1 can be configured to provide a lower temperature heating profile than Zone 2, but with the same flow rate of the heat transfer fluid. Moreover, as with the embodiment illustrated in FIG. 4B, because the heat transfer fluid flows from the fluid inlets 472a-c to the corresponding outlets 474a-c of each of the heating units 170a-c, the heat transfer fluid generally flows in the second direction 404 relative to the longitudinal axis L-L, which is generally opposite the direction that the ingredients move in the trough 290 during the popping process.

A person of ordinary skill in the relevant art will understand that the present technology includes other configurations, such as one in which Zone 1 and Zone 3 are fluidly coupled (and/or may have the same, or at least approximately the same, heating profile), Zones 1, 2, and 3 are all fluidly coupled (and/or may have the same, or at least approximately the same, heating profile), or none of the Zones 1, 2, or 3 are fluidly coupled or have the same heating profile, etc. Accordingly, multiple desired heating profiles can be achieved by varying the arrangements of the fluid conduits/inlets/outlets described herein, and/or by varying the temperatures and/or flow rates of the heat transfer fluid flowing out of the fluid heating and pump assembly 130. In some embodiments, the popcorn machine 150 can include fewer or more heating units 170a-c to define fewer or more heating zones, respectively, along the length of the trough 290. In some embodiments, each heating unit 170 can include a different number of inlets and/or outlets than the embodiments illustrated by example in FIGS. 4A-4C.

When using the trough heating system 106, it can be important to control the rate of heat transfer from the heat transfer fluid to the ingredients to ensure proper cooking. For example, in some instances cooking popcorn ingredients too quickly can produce small, hard kernels, while cooking popcorn ingredients too slowly can dry the kernels and impede proper popping. Accordingly, it can be desirable to control the input and output temperatures and/or flow rates of the heat transfer fluid to provide suitable ingredient heating profiles, such as those provided by other popcorn machines (e.g., kettle-based popcorn machines), while keeping the input temperature of the heat transfer oil sufficiently high to enable the kernels to reach the required popping temperature at the desired location on trough 290.

FIG. 4D illustrates a graph illustrating example changes in temperature of the heat transfer fluid and of the ingredients along the length of the trough 290 in accordance with some embodiments of the present technology. For example, FIG. 4D illustrates example changes in temperature of the heat transfer fluid when it flows through the heating units 170a-c in the second direction 404 (FIGS. 4B, 4C) generally opposite to the direction of travel of the ingredients along the trough 290. As illustrated, in some embodiments the heat transfer can be controlled such that the input temperature of the heat transfer fluid (e.g., the temperature when it leaves the fluid heating and pump assembly 130) is about 400° F., the output (or return) temperature of the heat transfer fluid (e.g., the temperature when it returns to the fluid heating and pump assembly 130 after transferring heat to the ingredients) is about 300° F., the input temperature of the ingredients (e.g., the temperature when they are placed into the popcorn machine 150) is about ambient temperature (e.g., about 70° F.), and the output temperature of the ingredients (e.g., the temperature when they are at the end of the trough 290) is about 400° F. To produce popcorn, for example, the corn may need to reach a temperature of about 320° F. to begin popping and then reach a temperature of about 420° F. for the entire batch to pop properly. In some embodiments, each of the input temperature and the output temperature of the heat transfer fluid can be about 100° F., 150° F., 200° F., 250° F., 300° F., 350° F., 400° F., 450° F., 500° F., 550° F., 600° F., 650° F., or 700° F., any value therebetween, lower, or higher. For example, the input temperature can be between 300−500° F. and/or the output temperature can be between 200−400° F.

One method of achieving the desired heat transfer rates of the heat transfer fluid and the ingredients, an example of which is illustrated in FIG. 4D, is to control the flow rate of the heat transfer fluid. In some embodiments, the flow rate of the heat transfer fluid can be about 4 gallons per minute (gpm), 8 gpm, 12 gpm, 16 gpm, 20 gpm, 24 gpm, 28 gpm, or 32 gpm, any value therebetween, less, or more (e.g., between 10−30 gpm or between 12−24 gpm). A relatively high flow rate can facilitate heat transfer from the heat transfer fluid to the ingredients, particularly in cases in which the heat transfer fluid does not undergo a phase change. In one example, the heat transfer fluid can be pumped into Zone 1 and Zone 2 at approximately 470° F. and 12 gpm and into Zone 3 at approximately 500° F. and 24 gpm. In some embodiments, controlling the flow rate to control the heat transfer can be particularly advantageous when the power output of the fluid heating and pump assembly 130 is fixed. In some embodiments, feedback from the temperature sensors 366 (FIG. 3C) can be used to determine and/or control the temperature and/or flowrate of the heat transfer fluid into the heating units 170a-c to provide a desired heating profile.

Furthermore, in some embodiments it can be desirable to pump the heat transfer fluid in a direction opposite the travel direction of the ingredients along the trough 290, as illustrated in FIGS. 4B-4C. The opposing flow directions can further facilitate (e.g., increase) heat transfer from the heat transfer fluid to the ingredients such that the temperature change of the heat transfer fluid is at a desired, relatively high value (e.g., a change of about 100° F., as shown in FIG. 4D).

Referring to FIGS. 4A-4D together, in addition to providing varied heating profiles, some embodiments of the heating units 170a-c can provide advantages over conventional heating systems by providing generally uniform heating across the surface of the trough 290. Conventional heating systems, for example, may include electrical heat elements positioned along the bottom portion of the trough 290. Providing heating only at the bottom portion of the trough 290 (or other discrete portions of the trough) can lead to temperature differentials between adjacent regions of the trough 290, which can result in warping of the trough 290. In contrast, embodiments of the heating units 170a-c described here can provide even and continuous (or at least relatively even and continuous) heating of the trough 290 via the heat transfer fluid flowing therethrough, thereby minimizing or at least reducing warping of the trough 290 during operation.

Those of ordinary skill in the art will appreciate that the trough heating system 106 and/or the components thereof (e.g., the heating units 170a-c) can be used with a wide variety of food cooking machines such as flow-through popcorn machines, kettle popcorn machines, etc.

Furthermore, the trough heating system 106 and/or the components thereof are not limited to use with the paddle assembly 381 and/or other popcorn machine features and embodiments described herein. For example, in some embodiments, the trough heating system 106 is used in a popcorn machine that moves ingredients down a trough using only an auger.

FIG. 5 is an isometric view of one of the paddles 382 configured in accordance with embodiments of the present technology. In the illustrated embodiment, the paddle 382 includes a paddle body 584, a distal blade 588, and a biasing member 586 disposed between the paddle body 584 and the blade 588. The paddle body 584 and/or the blade 588 can be made from Teflon, Delrin, metal, metal alloys (e.g., stainless steel), and/or other suitable materials via a variety of fabrication methods known in the art, including casting, machining, cutting, rolling, bending, welding, etc. The paddle body 584 includes a proximal or first end portion 584a coupled to an annular collar 581 via a spindle 583 that is fixedly attached to the collar 581 and extends radially outward therefrom. The collar 581 is configured to be adjustably coupled to the central shaft 354 (FIG. 3A). Although only a single paddle 382 is shown in FIG. 5, in the illustrated embodiment the collar 581 supports two paddles 382 on corresponding spindles 583 that extend outwardly from the collar 581 in diametrically opposite directions In other embodiments, the collar 581 can support one, three, four, five, or more paddles 382 on corresponding spindles 583. The paddle body 584 also includes a distal or second end portion 584b opposite the first end portion 584a. The blade 588 can be moveably coupled to the second end portion 584b via one or more fasteners 587 that fit into elongate (e.g., slotted) openings 589 in the blade 588. The openings 589 can be generally elongate in a radial direction such that the blade 588 can slide radially inward and outward relative to the paddle body 584 in response to external forces. Moreover, a distal edge portion 588b of the blade 588 can include a convex curvature corresponding to (e.g., matching, or at least approximately matching) a concave curvature of an inner surface of the trough 290 that the distal edge portion 588b contacts in operation.

The biasing member 586 is configured to resiliently bias the blade 588 outwardly and away from the shaft 354 and toward the inner surface of the trough 290 such that the distal edge portion 588b of the blade 588 contacts the inner surface of the trough 290 during operation of the popcorn machine 150. For example, the blade 588 can be movable between a radially outward position and a radially inward position, and the biasing member 586 can bias the blade 588 towards the radially outward position. Spring-loading or otherwise biasing the blade 588 in this manner can be advantageous because if the trough 290 warps during operation due to, for example, thermal stress, the blade 588 can maintain contact with the inner surface of the trough 290 notwithstanding deformations of the surface. In the illustrated embodiment, the biasing member 586 comprises a flexible and resilient material (e.g., stainless steel) in a sheet form that is deflected against a proximal edge portion 588a of the blade 588 opposite the distal edge portion 588b to bias the blade 588 radially outward. The sheet form of the biasing member 586 can facilitate cleaning of the biasing member 586. In other embodiments, the biasing member 586 can comprise a flexible and resilient material in a different form, e.g., a coil spring, leaf string, a rubber puck, etc. FIG. 3C illustrates the curved distal edge portion 588b of the blade 588 contacting the inner surface of the trough 290.

In the illustrated embodiment, axis A-A represents the longitudinal axis L-L along which the shaft 354 (FIG. 2) extends and rotates (e.g., in a clockwise direction CW when facing in the forward direction F, as shown), axis B-B represents a lateral axis perpendicular to and in the same horizontal plane as the longitudinal axis A-A, axis B′-B′ represents an axis parallel to and distanced radially outward from the lateral axis B-B, and axis C-C represents an axis parallel to a plane of the paddle body 584 and in the same horizontal plane as axis B′-B′. In other words, the axes B-B and B′-B′ lie on a plane perpendicular to the longitudinal axis L-L. Therefore, axis B′-B′ and axis C-C define an angle θ representing the non-zero angle of the paddle 382 relative to the lateral axis B-B, which is necessary to move ingredients in the tubular process chamber 255 along the longitudinal axis L-L as the shaft 354 rotates. In the illustrated embodiment, the angle θ can be from about +/−20 degrees to about +/−30 degrees from a plane perpendicular to the longitudinal axis of the central shaft 354. For example, as described in greater detail below, in some embodiments some of the paddles 382 can be positioned at angles θ of +25 degrees to move ingredients forward in the process chamber, and other paddles 382 can be positioned at angles θ of −25 degrees to move the ingredients backward in the process chamber. In other embodiments, the angle θ can have other values. For example, in some embodiments that angle be from about −90 degrees to about +90 degrees, from about −60 degrees to about +60 degrees, or about −30 degrees to +30 degrees. The paddle body 584 can be rotated about the spindle 583 to adjust the angle θ and then the paddle body 584 can be fixed in position. Moreover, because the paddles 382 are angled, the curvature of the distal edge portion 588b of the blade 588 contacting the trough 290 may be at least partly elliptical. In some embodiments, the elliptical curvature of the blade 588 is specific to a particular angle or a particular range of angles of the paddle 382.

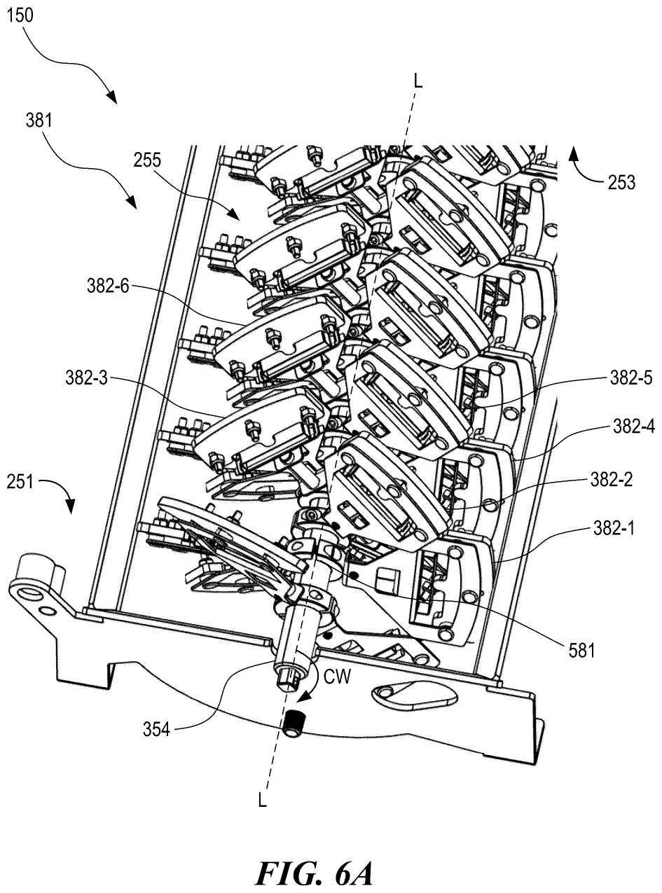

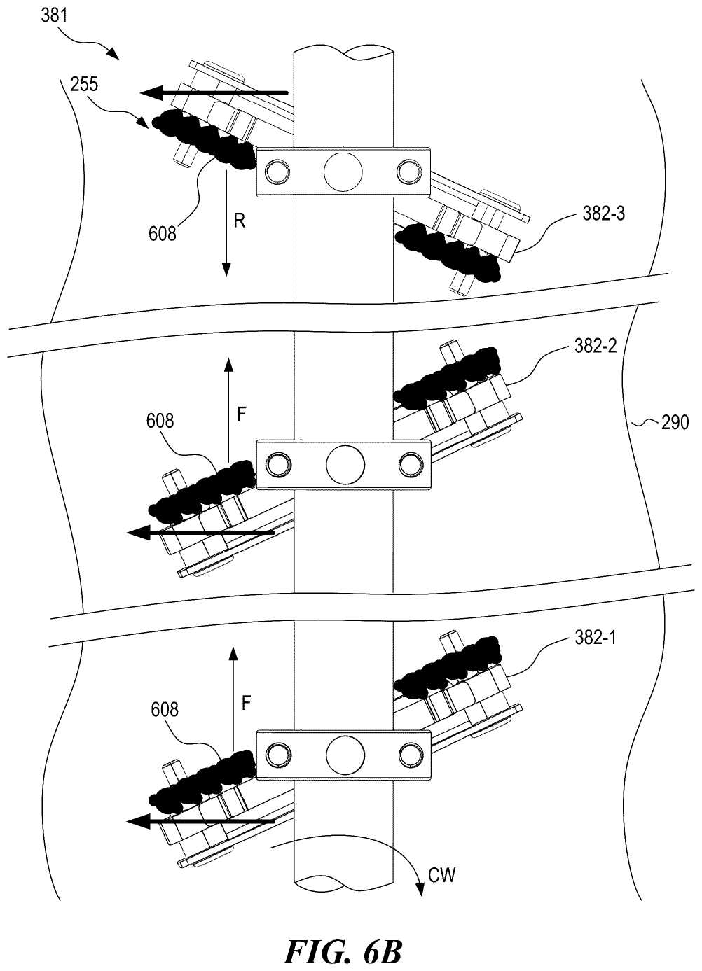

FIG. 6A is an isometric top view of the popcorn machine 150 illustrating the paddle assembly 381. As discussed further herein, a first subset of the paddles 382 can be oriented at a forward angle, and a second subset of the paddles 382 can be oriented at a backward angle. In the illustrated embodiment, each shaft collar 581 supports a pair of paddles 382, each positioned on opposite sides of the collar 581 (e.g., 180 degrees apart). In the illustrated embodiment, the shaft collars 581 are spaced apart by 0.5−2 inches from one another along the shaft 354 such that the paddles 382 are generally evenly distributed along the longitudinal axis L-L. In the illustrated embodiment, each pair of paddle spindles 583 is mounted to the shaft 354 at an angle of 60 degrees in a circumferential direction around the central shaft 354 relative to the adjacent pairs of paddle spindles 583 directly in front and behind, such that the angular positions of the paddle spindles 583 relative to the shaft 354 repeat every three shaft collars 581 (and hence every three pairs of paddles 382) along the shaft 354.

Six paddles 382, coupled to different but adjacent shaft collars 581, are labeled 382-1, 382-2, 382-3, 382-4, 382-5, and 382-6. Paddles 382-1 and 382-2 are oriented at the same positive (+) angle θ (FIG. 5) while paddle 382-3 is oriented at a negative (−) angle θ. For example, paddles 382-1 and 382-2 may be positioned at an angle θ of +25 degrees while paddle 382-3 may be positioned at an angle θ of −25 degrees. And as noted above, the pattern repeats every three pairs of paddles 382 such that paddles 382-4 and 382-5 are oriented the same as paddles 382-1 and 382-2, and paddle 382-6 is oriented the same as paddle 382-3. This pattern can continue along the longitudinal axis L-L. Moreover, in the illustrated embodiment, the paddles 382 are oriented such that the blades 588 face the direction they push the ingredients, enabling the blades 588, instead of the paddle bodies 584, to push the ingredients. It is appreciated that in other embodiments, the paddles 382 can be arranged in groups including a different number of paddles 382 (e.g., as opposed to in pairs, as illustrated).

FIG. 6B is a top view of three adjacent portions of the popcorn machine 150 showing the paddles 382-1, 382-2, and 382-3 when they are at the bottom-most points of their rotation cycles (e.g., pointing straight down in the trough 290). The other paddle of each pair is removed from view to avoid obscuring certain features of the present technology. Because each pair of paddles 382 is offset by 60 degrees in the circumferential direction around the central shaft 354 relative to the adjacent pairs of paddles 382, the paddles 382-1, 382-2, and 382-3 would each be at their bottom-most positions at different times during rotation of the shaft 354. Thus, FIG. 6B illustrates paddle 382-1 at a first time when it is in its bottom-most position, paddle 382-2 at a subsequent time when it is at its bottom-most position, and paddle 382-3 at a further subsequent time when it is at its bottom-most position. As the shaft 354 rotates in a clockwise direction CW, the paddle 382-1 moves from right to left in FIG. 6B across bottom portion of the trough 290 and, because the paddle 382-1 is set at a positive angle θ (e.g., +25 degrees; FIG. 5), the paddle 382-1 moves ingredients 608 in a forward direction F (i.e., toward the rear end portion 253 of the popcorn machine 150). As the shaft 354 continues to rotate in the clockwise direction CW, the paddle 382-2 reaches the bottom portion of the trough 290 moving from right to left. Because the paddle 382-2 is also positioned at a positive angles θ (e.g., +25 degrees), it also moves the ingredients 608 in the forward direction F. As the shaft 354 continues to rotate in the clockwise direction CW, the paddle 382-3 is next to reach the bottom-most portion of the trough 290 moving from right to left. However, because the paddle 382-3 is positioned at a negative angle θ (e.g., −25 degrees), the paddle 382-3 moves the ingredients 608 in the rearward direction R (i.e., toward the front end portion 251 of the popcorn machine 150). In the foregoing manner, the paddle assembly 381 efficiently mixes the ingredients in the process chamber 255 to consistently produce high quality popcorn with taste and texture that is uniform across the batch.

To ensure that the ingredients gradually move down the length of the trough 290 and eventually reach the rear end portion 253, in some embodiments, the popcorn machine 150 can include more paddles 382 set at positive angles θ than paddles 382 set at negative angles θ. For example, in the illustrated embodiment, the number of forward paddles is twice the number of backward paddles. In other embodiments, the ratio of forward paddles to backward paddles can be 1:1, 3:1, or other values. In some embodiments, the net forward movement of ingredients can be accomplished by making the surface area of the forward paddles collectively greater than the surface area of the backward paddles. In some embodiments, the net forward movement can be accomplished by orienting the forward paddles at a positive angle θ and orienting the backward paddles at a negative angle θ that is greater in magnitude than the positive angle θ. By having some paddles “face forward” and other paddles “face backward,” the popcorn machine 150 can benefit from the improved mixing and heat distribution achieved by moving the ingredients back and forth without having to change the direction of rotation of the shaft 354. Changing rotation of the shaft at certain timing intervals can lead to increased wear and reduced efficiency and lifespan of the motor.

A person of ordinary skill in the relevant art will understand that the present technology may include embodiments with only some or all of the elements or steps shown and described above with reference to FIGS. 1-6B. For example, in some embodiments, popcorn machines configured in accordance with the present disclosure can includes the paddle assembly 381 but not the heating units 170a-c. In other embodiments, popcorn machines configured in accordance with the present disclosure can include the heating units 170a-c but not the paddle assembly 381. In further embodiments, popcorn machines configured in accordance with the present disclosure can include both the paddle assembly 381 and the heating units 170a-c.

As used herein, the use of relative terminology, such as “about”, “generally”, “approximately”, “substantially” and the like refer to the stated value plus or minus ten percent. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art.

### CONCLUSION

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize. The teachings of the present technology provided herein can be applied to other systems, not necessarily the system described herein. The elements and acts of the various embodiments described herein can be combined to provide further embodiments. Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

I/We claim:

1. A popcorn machine system, comprising:
a popcorn machine having an external surface, a front end portion, and a rear end portion, and defining a process chamber extending between the front end portion and the rear end portion; and
one or more heating units coupled to the external surface of the popcorn machine, wherein each of the one or more heating units at least partially defines an interior chamber and includes an inlet to the interior chamber and an outlet from the interior chamber, and wherein the interior chamber is configured to receive a heat transfer fluid via the inlet and expel the heat transfer fluid via the outlet such that heat is transferred from the heat transfer fluid flowing through the interior chamber to the process chamber of the popcorn machine.

2. The popcorn machine system of claim 1, wherein the popcorn machine includes a trough and a cover movably coupled to the trough, and wherein each of the one or more heating units is coupled to an external surface of the trough.

3. The popcorn machine system of claim 1, wherein each of the one or more heating units includes an outer wall having a peripheral edge portion sealably attached to the popcorn machine via a continuous seam weld, and wherein the outer wall and the external surface of the popcorn machine together define the interior chamber.

4. The popcorn machine system of claim 1, wherein each of the one or more heating units includes a hollow, enclosed structure that defines the interior chamber independently of the process chamber.

5. The popcorn machine system of claim 1, wherein each of the one or more heating units is coupled to the external surface of the popcorn machine via a plurality of spotwelds, and wherein each of the plurality of spotwelds is configured to obstruct and thereby distribute flow of the heat transfer fluid through the interior chamber.

6. The popcorn machine system of claim 1, wherein the heat transfer fluid includes oil.

7. The popcorn machine system of claim 1, wherein a first temperature of the heat transfer fluid received via the inlet of each of the one or more heating units is between 300−500° F., and wherein a second temperature of the heat transfer fluid expelled via the outlet of each of the one or more heating units is between 200−400° F.

8. The popcorn machine system of claim 1, wherein a flow rate of the heat transfer fluid through the interior chamber of each of the one or more heating units is between 10−30 gallons per minute.

9. The popcorn machine system of claim 1, wherein the one or more heating units includes:
a first heating unit coupled to the front end portion of the popcorn machine;
a second heating unit; and
a third heating unit coupled to the rear end portion of the popcorn machine, wherein the second heating unit is positioned between the first and third heating units,
wherein a first inlet of the first heating unit and a second inlet of the second heating unit are coupled to share and receive a first stream of the heat transfer fluid, and
wherein a third inlet of the third heating unit is coupled to receive a second stream of the heat transfer fluid different from the first stream of the heat transfer fluid.

10. The popcorn machine system of claim 1, wherein the one or more heating units includes:
a first heating unit coupled to the front end portion of the popcorn machine;
a second heating unit; and
a third heating unit coupled to the rear end portion of the popcorn machine, wherein the second heating unit is positioned between the first and third heating units,
wherein a first inlet of the first heating unit is coupled to receive a first stream of the heat transfer fluid, and
wherein a second inlet of the second heating unit and a third inlet of the third heating unit are coupled to share and receive a second stream of the heat transfer fluid different from the first stream of the heat transfer fluid.

11. The popcorn machine system of claim 1, wherein the one or more heating units includes:
a first heating unit coupled to the front end portion of the popcorn machine;
a second heating unit; and
a third heating unit coupled to the rear end portion of the popcorn machine, wherein the second heating unit is positioned between the first and third heating units,
wherein a second inlet of the second heating unit is coupled to receive a first stream of the heat transfer fluid,
wherein a first inlet of the first heating unit is coupled to receive the first stream of the heat transfer fluid expelled via an outlet of the second heating unit, and
wherein a third inlet of the third heating unit is coupled to receive a second stream of the heat transfer fluid different from the first stream of the heat transfer fluid.

12. The popcorn machine system of claim 1, further comprising an ingredient moving assembly disposed in the process chamber and configured to move ingredients through the process chamber from the front end portion to the rear end portion, wherein the inlet of each of the one or more heating units is positioned closer to the front end portion of the popcorn machine than the outlet of the respective heating unit such that the heat transfer fluid flows in a same direction along the popcorn machine as the ingredients.

13. The popcorn machine system of claim 1, further comprising an ingredient moving assembly disposed in the process chamber and configured to move ingredients through the process chamber from the front end portion to the rear end portion, wherein the inlet of each of the one or more heating units is positioned closer to the rear end portion of the popcorn machine than the outlet of the respective heating unit such that the heat transfer fluid flows in an opposite direction along the popcorn machine compared to the ingredients.

14. A popcorn machine system, comprising:
a popcorn machine having a front end portion and a rear end portion and a defining a process chamber extending between the front end portion and the rear end portion, wherein the process chamber is configured to receive ingredients therein;
a central shaft disposed in the process chamber and extending between the front and rear end portions of the popcorn machine;
a motor operably coupled to the central shaft and configured to rotate the central shaft about a longitudinal axis of the central shaft; and
a plurality of paddles each coupled to the central shaft, wherein a first subset of the plurality of paddles is oriented at a forward angle to move the ingredients towards the rear end portion of the popcorn machine when the motor rotates the central shaft in a first direction, and wherein a second subset of the plurality of paddles is oriented at a backward angle to move the ingredients towards the front end portion of the popcorn machine when the motor rotates the central shaft in the first direction.

15. The popcorn machine system of claim 14, wherein the plurality of paddles includes a plurality of paddle pairs, wherein different paddle pairs are coupled to different points along a length of the central shaft, and wherein paddles of each paddle pair extend radially outward from the central shaft in opposite directions.

16. The popcorn machine system of claim 14, the plurality of paddles is arranged in a repeating pattern of three paddle groups such that (i) paddles of a first paddle group and a second paddle group of the repeating pattern of three paddle groups are each oriented at the forward angle and (ii) paddles of a third paddle group of the repeating pattern of three paddle groups are each oriented at the backward angle.

17. The popcorn machine system of claim 16, wherein the first, second, and third paddle groups are offset from one another by 60 degrees in a circumferential direction around the central shaft.

18. The popcorn machine system of claim 14, wherein the forward angle is between +20 degrees and +30 degrees from a plane perpendicular to the longitudinal axis of the central shaft, and wherein the backward angle is between −20 degrees and −30 degrees from the plane perpendicular to the longitudinal axis of the central shaft.

19. The popcorn machine system of claim 14, wherein each of the plurality of paddles includes:
a paddle body coupled to the central shaft;
a distal blade movably coupled to the paddle body, wherein the distal blade is movable between a radially distal position and a radially proximal position, wherein the distal blade includes a curved distal edge portion; and
a biasing member coupled to the paddle body and configured to bias the distal blade towards the radially distal position.

20. The popcorn machine system of claim 14, further comprising a helical auger coupled to the central shaft and positioned closer to the rear end portion of the popcorn machine than the plurality of paddles.
